(19) United States
(12) Patent Application Publication
(10) Pub. No.: US 2006/0084413 A1
(43) Pub. Date: Apr. 20, 2006

(54) Mobile terminal for real-time audio file downloading and method thereof

(75) Inventor: Jeong-Yong Myoung, Daejeon (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/251,684

(22) Filed: Oct. 17, 2005

(30) Foreign Application Priority Data
Oct. 20, 2004 (KR) 2004-0083813

(51) Int. Cl. H04M 1/725

(52) U.S. Cl. 455/412.1; 455/567

(57) ABSTRACT

A mobile terminal enabling real-time bell sound downloading and coloring services by data communication with a service file download server without requiring separate manipulation of the terminal by a user is disclosed. The mobile terminal includes a profile managing module for comparing a profile set in the mobile terminal and a profile set in the service file download server and thereby determining whether to download a service file; and an RF (Radio Frequency) module for transmitting a service file download request message to the service file download server.

### PRIORITY

This application claims priority under 35 U.S.C. § 119 to an application entitled “Mobile Terminal For Real Time Audio File Downloading And Method Thereof” filed in the Korean Intellectual Property Office on Oct. 20, 2004 and assigned Serial No. 2004-0083813, the contents of which are incorporated herein by reference.

### BACKGROUND OF THE INVENTION

1. Field of the Invention

The present invention relates to a mobile terminal enabling real-time bell sound downloading and coloring services, and more particularly, to a mobile terminal enabling real-time bell-sound downloading and coloring services by data communication with a service file download server without a separate manipulation of the terminal by a user.

2. Background of the Prior Art

Recently, use of mobile terminals have marked by increased in number and functions of the mobile terminal. Typical examples of the use functions include a bell sound-downloading function and a coloring function.

Mobile terminal manufacturer typically provides various bell sounds (e.g., beeps, other tunes, etc.) so as to satisfy customers' interests. Alternatively, musical selections, and various songs instead of monotonous bell sounds are used as the bell sound of a mobile terminal, whereby the mobile terminal's bell sound can be distinguished from other mobile terminals' bell sounds by the mobile terminal's user. Additionally, musical selections generated as the bell sounds can entertain people in the vicinity of the mobile terminal who hear the sounds.

However, users easily get bored with the same bell sound, and thus it is desirable to replace an existing bell sound with a new bell sound.

The coloring function provides various call connection sounds, wherein the call connection sound is a musical selection provided to a caller immediately upon or soon after dialing. That is, the coloring function provides a caller with a musical selection instead of a dial tone to reduce tedium on the part of the mobile terminal user before a call is connected.

A bell sound service provider provides a bell sound service to a user desiring to change manufacture installed bell sounds. The user accesses a bell sound service-providing server and then can download a desired musical selection through a given procedure. The coloring function can be used in the same manner as the bell sound-downloading function.

Accordingly, in the conventional method as described above, a user downloads a bell sound file and a coloring file by choosing a desired musical selection at a desired time. That is, the downloading of a bell sound file and a coloring file in the conventional mobile terminal requires continuous management of the terminal by a user, whereby the user has to personally download a bell sound file and set a coloring service.

However, it is desirable to provide service that continuously maintains and if need be provides music information for continuous management of the service by the user, which obviates the need for a user to personally monitor music information and/or to personally have to download a bell sound file and/or a coloring file which can cause a great inconvenience to the user.

### SUMMARY OF THE INVENTION

The present invention provides a mobile terminal which can automatically set a bell sound and a coloring service through a predetermined data communication with a service file download server even if the mobile terminal's user does not personally download a bell sound or set a coloring service.

According to an aspect of the present invention, a mobile terminal capable of a real-time downloading of a service file from a service file download server, includes: a profile managing module for comparing a profile set in the mobile terminal with a profile set in the service file download server and thereby determining whether to download a service file; and an RF (Radio Frequency) module for transmitting a service file download request message to the service file download server.

The profile managing module may periodically transmit a profile compare request message to the service file download server.

The profile compare request message may include a service file ID (Identification) currently set in the mobile terminal and the mobile terminal's phone number.

The profile managing module may compare a profile set in the mobile terminal with a profile received from the service file download server and may download a service file from the service file download server if the two profiles are not the same.

The profile managing module may transmit a service file download request message to the service file download server in response to a download indication message received from the service file download server when a service file set in the service file download server is changed.

The profile managing module may transmit a service file download request message to the service file download server in response to a compare request message periodically received from the service file download server.

According to another aspect of the present invention, a real-time service file downloading method in a mobile terminal includes the steps of: periodically transmitting a profile compare request message from the mobile terminal to a service file download server; receiving a service file download indication message from the service file download server, if a profile periodically received from the mobile terminal and profile set in the service file download server are not the same; and downloading a service file from the service file download server in response to the service file download indication message.

The profile compare request message may include a service file ID currently set in the mobile terminal and the mobile terminal's phone number.

According to a further another aspect of the present invention, a real-time service file downloading method in a mobile terminal includes the steps of: receiving a service file download indication message from a service file download server when a service file set in the service file download server is changed; and downloading a service file from the service file download server in response to the service file download indication message.

According to still another aspect of the present invention, a real-time service file downloading method in a mobile terminal includes the steps of: periodically receiving a profile compare request message from a service file download; comparing a profile periodically received from the service file download server with a profile set in the mobile terminal; and downloading a service file if the profile periodically received from the service file download server and the profile set in the mobile terminal are not the same.

The profile compare request message may include a service file ID currently set in the service file download server and the mobile terminal's phone number.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile terminal according to an embodiment of the present invention;

FIG. 2A is a diagram illustrating a bell sound-downloading method in a mobile terminal, according to an embodiment of the present invention;

FIG. 2B is a diagram illustrating a bell sound-downloading method in a mobile terminal, according to another embodiment of the present invention; and

FIG. 2C is a diagram illustrating a bell sound-downloading method in a mobile terminal, according to a further another embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Also, when it is determined that the subject of the invention may be made ambiguous by a detailed description, the detailed description will be omitted.

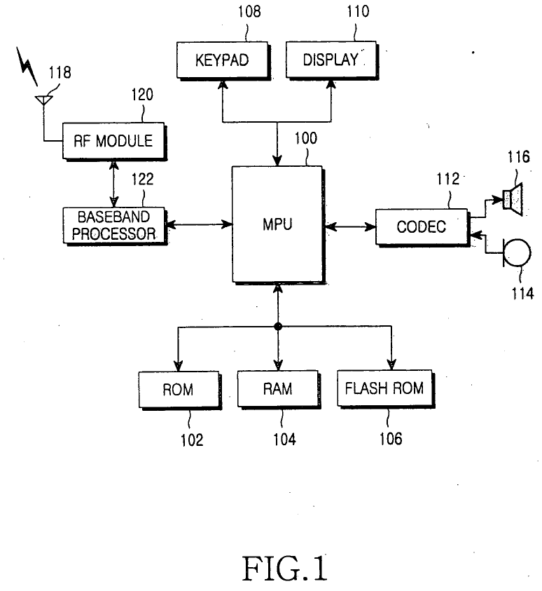

FIG. 1 is a block diagram of a mobile communication terminal according to an embodiment of the present invention.

A mobile communication terminal (herein after mobile terminal) which will be described below can for example include a cellular phone, a Personal Communication System (PCS) terminal, a Personal Data Assistant (PDA), an International Mobile Communication 2000 (IMT-2000) terminal and other similar devices. The following descriptions will be made with a general structure of the above mobile terminals.

Referring to FIG. 1, a MicroProcessor Unit (MPU) 100 controls an overall operation of a mobile terminal. For example, the MPU 100 processes and controls voice communication and data communication. In addition to the typical functions, the MPU 100 performs periodic communication with a service file download server by using a service profile-managing module included therein (a bell sound file download server by using a bell sound profile-managing module included therein and/or a coloring file download server by using a coloring profile-managing module included therein). Because the typical process and control operation of MPUs are well known in the art, a description about the typical process and control operation of the MPU 100 will be omitted.

A Read Only Memory (ROM) 102 stores a variety of reference data and microcodes of a program for the process and control operation of the MPU 100. The ROM 102 is a nonvolatile memory and thus can retain data regardless of the power being supplied to it.

A Random Access Memory (RAM) 104 is a volatile memory and serves as a working memory of the MPU 100. The RAM 104 stores temporary data that is created during the execution of various programs.

A flash ROM 106 is a nonvolatile memory which can store various updateable data and can be used for storing data such as database functions, etc. (e.g., a phone book).

A keypad 108 includes numeric keys of digits 0-9 and a plurality of function keys, such as a Menu key, a Cancel (delete) key, a Confirmation key, a Talk key, an End key, an Internet connection key, navigation keys (up/down/right/left), etc. The keypad 108 provides key input data corresponding to keys pressed by a user to the MPU 100.

The four navigation keys are preferably used as hot keys, which allow specific menu items (e.g., a message management (←), a phone book (→), a top-level menu list (↑) and a music box (↓)) to be directly applied. In general, the mobile terminal preferably uses two keys (e.g., a menu key and a navigation key) for entering the top-level menu list.

A display unit 110 is used for displaying status information, characters of a predetermined length, moving pictures, still pictures, etc, as is necessary or desired by the user or the mobile terminal. A color Liquid Crystal Display (LCD) may be used as the display unit 110.

A Coder-Decoder (CODEC) 112 connected to the MPU 100, a speaker 116 and a microphone 114 constitute an audio input/output block that is used for telephone communication and voice recording. The MPU 100 produces PCM (Pulse Code Modulation) data and the CODEC 112 converts the PCM data into analog audio signals. The analog audio signals are outputted through the speaker 116. Also, the CODEC 112 converts audio signals received through the microphone 114 into PCM data and provides the PCM data to the MPU 100.

A Radio Frequency (RF) module 120 down-converts a frequency of an RF signal received through an antenna 118 and provides the resulting baseband signal to a baseband processor 122. Also, the RF module 120 up-converts a frequency of a baseband signal provided from the baseband processor 122 and transmits the resulting baseband signal through the antenna 118. The baseband processor 122 processes the baseband signals that are exchanged between the RF module 120 and the MPU 100.

For example, in the case of the data transmission, the baseband processor 122 performs a channel coding and spreading on the transmitting data. In the case of the data reception, the baseband processor 122 performs a despreading and channel decoding on the receiving data.

That is, the baseband processor 122 decodes a variety of channels (e.g., paging channels, traffic channels, etc.) that are received from a base station, and/or generates a variety of channels (e.g., access channels, traffic channels, etc.) that are to be transmitted to the base station.

The present invention makes it possible to automatically set a bell sound of a mobile terminal by exchanging messages between a bell-sound profile-managing module (client) and a service file download server even if the mobile terminal's user does not personally select a bell sound of the mobile terminal. Here, an operation between the client and the server can be initiated by either the client or the server.

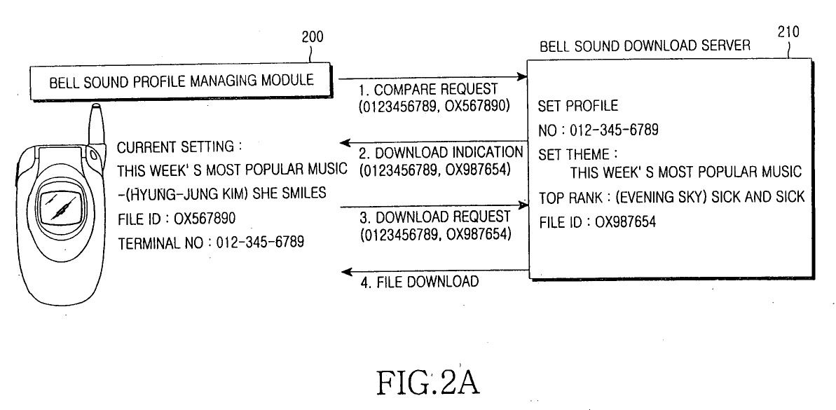

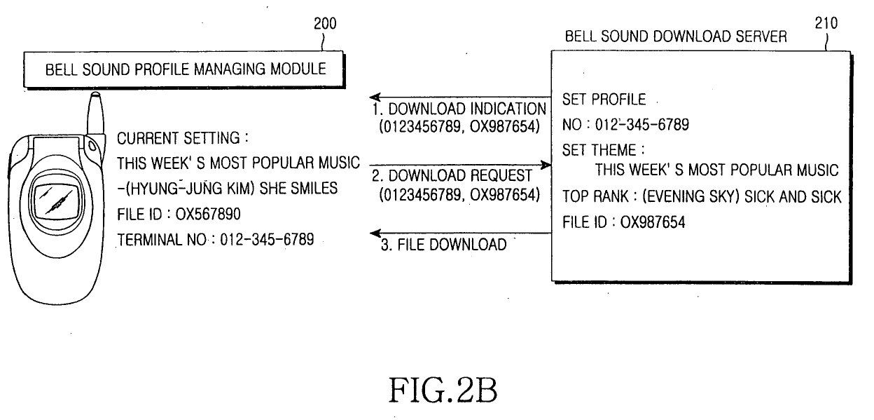

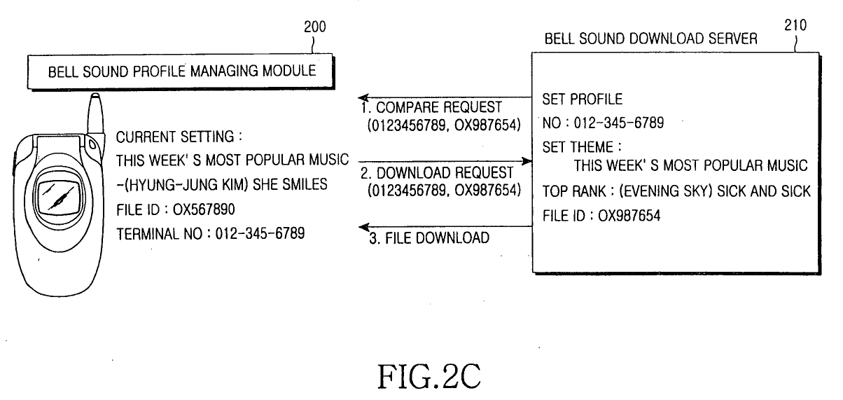

FIG. 2A is a diagram illustrating a bell sound-downloading method of a mobile terminal according to an embodiment of the present invention.

Referring to FIG. 2A, a bell-sound profile-managing module 200 (hereinafter referred to as managing module 200) of a mobile terminal transmits a profile set in the terminal to a bell sound download server 210 (hereinafter referred to as server 210). The server 210 periodically provides a bell sound download service. The set profile is a currently-set theme for bell-sound downloading, and thus includes a name (or other identifiers) of a currently-used bell sound. That is, firstly, the managing module 200 periodically transmits a COMPARE REQUEST message for transmission of the set profile to the server 210. The COMPARE REQUEST message includes the phone number of the mobile terminal (e.g., 012-345-6789) and the profile set in the mobile terminal, namely an ID (for example, OX567890) of a bell sound file currently set in the mobile terminal.

Upon receipt of the COMPARE REQUEST message from the managing module 200, the server 210 checks the phone number included in the received COMPARE REQUEST message, and then searches a profile set for the phone number. For example, when a selection such as “THIS WEEK'S MOST POPULAR MUSIC” has been set as a bell sound theme for the phone number (for example, 012-345-6789), the server 210 searches a database or other music storage device, etc. for music corresponding to the set bell-sound theme. The search can be made by searching for an ID assigned to the music corresponding to the set bell sound theme from a database, etc.

The phone number included in the received COMPARE REQUEST message acts as a user ID. Accordingly, the server 210 can identify an individual user by the received phone number.

According to the profile search, the server 210 compares a bell sound file ID (for example, OX987654) currently set therein with the received bell sound file ID (for example, OX567890 which was set in the COMPARE REQUEST message). If the bell sound file ID currently set in the server 210 is identical to the received file ID from the result of the comparison, the server 210 does not transmit a DOWNLOAD INDICATION message (which will be described below). Accordingly, the mobile terminal does not download any bell sound file.

Alternatively, if the bell sound file ID currently set in the server 210 is different from the received bell sound file ID upon completion of the comparison, the server 210 transmits a DOWNLOAD INDICATION message to the mobile terminal.

The DOWNLOAD INDICATION message which is used is a message for commanding the managing module 200 to download a bell sound file, which indicates that a new bell sound file has been set in the server 210. The DOWNLOAD INDICATION message includes a newly-set bell sound file ID (for example, OX987654) and the phone number (for example, 012-345-6789) of the mobile terminal. The newly set bell sound ID and the phone number are used for preventing the DOWNLOAD INDICATION message from being mistakenly transmitted to other mobile terminals, or for allowing the newly-set bell sound file to be properly downloaded according to the phone number.

Upon receipt of the DOWNLOAD INDICATION message from the server 210, the managing module 200 checks the phone number included in the DOWNLOAD INDICATION message and determines whether the phone number (for example, 012-345-6789) included in the DOWNLOAD INDICATION message matches the phone number of the mobile terminal.

Based on the above determination, if the DOWNLOAD INDICATION message is identified for the managing module 200 (because the phone numbers match), the managing module 200 transmits a DOWNLOAD REQUEST message to the server 210. Here, the DOWNLOAD REQUEST message includes the mobile terminal's phone number and the newly-set bell sound file ID.

Upon receipt of the DOWNLOAD REQUEST message from the managing module 200, the server 210 sets a connection with the mobile terminal and then transmits the newly-set bell sound file to the managing module 200. Upon receipt of the newly-set bell sound file, the managing module 200 sets the newly-set bell sound file as a new bell sound instead of the previously-set bell sound file.

In the bell sound downloading method illustrated in FIG. 2A, a bell sound download request is first performed by the managing module 200 of the mobile terminal. That is, in response to a periodic bell sound file comparison request by the managing module 200, the server 210 determines whether a bell sound download is necessary, and then informs the managing module 200 of the determination, thereby making it possible to automatically update a bell sound of the mobile terminal.

FIG. 2B is a diagram illustrating a bell sound-downloading method of a mobile terminal according to another embodiment of the present invention.

Referring to FIG. 2B, contrary to the bell sound downloading method illustrated in FIG. 2A, the bell sound downloading method illustrated in FIG. 2B is characterized in that the server 210 firstly commands all the terminals, which are to receive a bell sound file download service, to update a bell sound file when set bell sound files of the server 210 are changed.

For this, the server 210 checks whether a set bell sound file of each theme is changed. Here, the server 210 can set various themes, and can also set various bell sound files per each theme.

The server 210 periodically (or in alternative embodiments, non-periodically) checks whether a set bell sound file is changed per each theme. Accordingly, whenever the set bell sound files in the server 210 are changed, the server 210 commands corresponding mobile terminals to update a bell sound file.

Accordingly, when a set bell sound file of a theme is changed, the server 210 firstly transmits a DOWNLOAD INDICATION message to all mobile terminals having the theme as a set theme.

Here, the DOWNLOAD INDICATION message includes the phone number (for example, 012-345-6789) of the mobile terminal to receive the DOWNLOAD INDICATION message, and an ID (for example, OX987654) of a bell sound file to be downloaded to the mobile terminal.

Secondly, upon receipt of the DOWNLOAD INDICATION message from the server 210, the managing module 200 of the mobile terminal transmits a DOWNLOAD REQUEST message to the server 210.

Here, the DOWNLOAD REQUEST message includes the mobile terminal's phone number (for example, 012-345-6789) and the ID (for example, OX987654) of the bell sound file to be downloaded from the server 210.

Thirdly, upon receipt of the DOWNLOAD REQUEST message from the managing module 200, the server 210 sets a connection with the mobile terminal and then transmits the bell sound file to the managing module 200.

FIG. 2C is a diagram illustrating a bell sound-downloading method of a mobile terminal according to a further another embodiment of the present invention.

Referring to FIG. 2C, firstly, the server 210 transmits a COMPARE REQUEST message to the managing module 200. Here, the COMPARE REQUEST message includes the phone number (for example, 012-345-6789) of the mobile terminal to periodically receive the message, and an ID (for example, OX987654) of a bell sound file currently set in the server 210.

Upon receipt of the COMPARE REQUEST message from the server 210, the managing module 200 compares an ID (for example, OX567890) of a bell sound file currently set in the mobile terminal with the received bell sound file ID (for example, OX987654). If the ID of the bell sound file currently set in the mobile terminal is identical to the received bell sound file when comparing, the managing module 210 performs no operation.

Secondly, if the ID of the bell sound file currently set in the mobile terminal is different from the received bell sound file, the managing module 200 transmits a DOWNLOAD REQUEST message to the server 210. Here, the DOWNLOAD REQUEST message includes the mobile terminal's phone number (for example, 012-345-6789) and the ID (for example, OX987654) of the bell sound file to be downloaded from the server 210.

Thirdly, upon receipt of the DOWNLOAD REQUEST message from the managing module 200, the server 210 sets a connection with the mobile terminal and then transmits the bell sound file currently set therein to the managing module 200. Accordingly, the mobile terminal can use an updated bell sound file.

As described previously, the present invention enables the managing module 200 to constantly download a new bell sound file by communication with the server 210. Although a bell sound theme is set to “THIS WEEK'S MOST POPULAR MUSIC” in the aforementioned embodiments of the present invention, the bell sound theme can be diversified to cover various bell sounds as desired.

In addition, the present invention can be identically applied to a coloring service. That is, a coloring service can be automatically updated by exchange of messages between a coloring service client and a coloring service-providing server. At this time, a base station may act as the coloring service client. Accordingly, the base station and the coloring service-providing server can update a coloring service by exchanging predetermined messages therebetween as described previously.

As stated above, the present invention makes it possible to automatically set a bell sound and a coloring service by predetermined data communication with a service file download server even if the mobile terminal's user does not personally download a bell sound or set a coloring service.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A mobile terminal comprising:
a service profile managing module for comparing a profile set in the mobile terminal with a profile received from a service file download server and for determining whether to download a service file from the service file download server based on the comparison; and
an RF (Radio Frequency) module for transmitting a service file download request message to the service file download server if the service profile managing module determines to download the service file from the service file download server.

2. The mobile terminal of claim 1, wherein the service file from the service file download server is one of a bell sound file and a coloring file.

3. The mobile terminal of claim 1, wherein the service profile managing module compares the profile set in the mobile terminal with the profile received from the service file download server in response to a compare request message received from the service file download server.

4. The mobile terminal of claim 1, wherein the service profile managing module determines to download the service file from the service file download server when the profile set in the mobile terminal differs from the profile received from the service file download server.

5. A mobile terminal comprising:
a service profile managing module for periodically transmitting a profile compare request message to a service file download server, and for receiving a service file download indication message from the service file download server when the service file download server determines that a profile set received from the mobile terminal is different from a profile set in the service file download server, and for to determining whether to download a service file from the service file download server; and
an RF (Radio Frequency) module for transmitting a service file download request message to the service file download server when the service profile managing module determines to download the service file from the service file download server.

6. The mobile terminal of claim 5, wherein the profile compare request message includes a service file ID currently set in the mobile terminal and the mobile terminal's phone number.

7. The mobile terminal of claim 5, wherein the service file from the service file download server is one of a bell sound file and a coloring file.

8. A mobile terminal comprising:
a service profile managing module for receiving a service file download indication message from the service file download server when the service file download server determines that a profile set in the service file download server has been changed, and for determining whether to download a service file from the service file download server; and
an RF (Radio Frequency) module for transmitting a service file download request message to the service file download server when the service profile managing module determines to download the service file from the service file download server.

9. The mobile terminal of claim 8, wherein the service file from the service file download server is one of a bell sound file and a coloring file.

10. A mobile terminal comprising,
a service profile managing module for comparing a profile set in the mobile terminal with a profile received from a service file download server and for determining whether to download a service file from the service file download server;
an RF (Radio Frequency) module for transmitting a service file download request message to the service file download server if the service profile managing module determines to download the service file from the service file download server; and
a memory for storing the service file downloaded from the service file download server.

11. A mobile terminal comprising:
a service profile managing module for periodically transmitting a profile compare request message to a service file download server, for receiving a service file download indication message from the service file download server when the service file download server determines that a profile set received from the mobile terminal is different from a profile set in the service file download server, and for determining whether to download a service file from the service file download server upon receipt of the service file download indication message;
an RF (Radio Frequency) module for transmitting a service file download request message to the service file download server when the service profile managing module determines to download the service file from the service file download server; and
a memory for storing the service file downloaded from the service file download server.

12. A mobile terminal comprising:
a service profile managing module for receiving a service file download indication message from the service file download server when the service file download server determines that a profile set in the service file download server has been changed, and thereby to determine to download a service file from the service file download server;
an RF (Radio Frequency) module for transmitting a service file download request message to the service file download server when the service profile managing module determines to download the service file from the service file download server; and
a memory for storing the service file downloaded from the service file download server.

13. A real-time service file downloading method in a mobile terminal, comprising the steps of:
periodically transmitting a profile compare request message from the mobile terminal to a service file download server;
receiving a service file download indication message from the service file download server if a profile periodically received from the mobile terminal and a profile set in the service file download server are not the same; and
downloading a service file from the service file download server in response to the service file download indication message.

14. The method of claim 13, wherein the profile compare request message includes a service file ID currently set in the mobile terminal and the mobile terminal's phone number.

15. The method of claim 13, wherein the service file from the service file download server is one of a bell sound file and a coloring file.

16. A real-time service file downloading method in a mobile terminal, comprising the steps of:
receiving a service file download indication message from a service file download server when a service file set in the service file download server is changed; and
downloading a service file from the service file download server in response to the service file download indication message.

17. The method of claim 16, wherein the service file from the service file download server is one of a bell sound file and a coloring file.

18. A real-time service file downloading method in a mobile terminal, comprising the steps of:
periodically receiving a profile compare request message from a service file download server;
comparing a profile periodically received from the service file download server with a profile set in the mobile terminal; and
downloading a service file if the profile periodically received from the service file
download server and the profile set in the mobile terminal are not the same.

19. The method of claim 18, wherein the profile compare request message includes a service file ID currently set in the service file download server and the mobile terminal's phone number.

20. The method of claim 18, wherein the service file from the service file download server is one of a bell sound file and a coloring file.
